(19) United States
(12) Patent Application Publication
(10) Pub. No.: US 2023/0231761 A1
(43) Pub. Date: Jul. 20, 2023

(54) MONITORING CAUSATION ASSOCIATED WITH NETWORK CONNECTIVITY ISSUES

(71) Applicant: VMware, Inc., Palo Alto, CA (US)

(72) Inventor: Austin John Kramer, Redwood City, CA (US)

(21) Appl. No.: 17/578,645

(22) Filed: Jan. 19, 2022

(51) Int. Cl. H04L 41/0631; H04L 43/0829; H04L 43/10; H04L 43/0811

(52) U.S. Cl. CPC H04L 41/064; H04L 43/0829; H04L 43/10; H04L 43/0811

(57) ABSTRACT

Described herein are systems, methods, and software to identify causes of connectivity issues in a computing environment. In one example, a computing system monitors network characteristics associated with the computing system and identifies an error notification from a service on the computing system that indicates a connectivity issue with one or more other computing systems. In response to the error notification, the computing system identifies additional network characteristics associated with connections to the one or more other computing system and determines one or more probable causes of the connectivity issue based on the network characteristics and additional network characteristics. The computing system can then generate a summary using the one or more probable causes.

### TECHNICAL BACKGROUND

Computing environments often employ virtualization to better utilize the physical resources of the physical computing systems. The virtualization may comprise virtual machines, containers, or other virtualized endpoints, and may further comprise virtualized network appliances including firewalls, routers, switches, or some other virtualized network appliance. In some implementations, the physical computing systems, including host servers, may communicate to exchange various information. The information may be used to track resource usage on the computing systems, manage migration of virtual machines between computing systems, modify the configuration associated with the network appliances or virtual endpoints, or provide some other operation in association with managing the virtualization configuration in a computing environment.

In some implementations, network connectivity issues may occur that prevent a first computing system to communicate with one or more other computing systems in the computing environment. For example, the first computing system may comprise a management server that can be used to configure and manage resources for virtual endpoints and virtualized network appliances across other physical computing systems. While communicating with the other computing systems, a connection between the first computing system and at least one other computing system can fail, causing an error in the computing environment. However, difficulties can arise in determining what caused the connection failure and, in turn, how to fix the error for the computing environment.

### SUMMARY

The technology described herein manages the identification of network connectivity errors and the identification of one or more probable causes associated with the network connectivity errors. In one implementation, a computing system may monitor network characteristics for at least one network interface of the computing system. The computing system may further identify an error notification from a service on the computing system indicative of a connectivity issue with at least one other computing system and, in response to the error notification, identify additional network characteristics associated with one or more connections to the at least one other computing system. The computing system further determines one or more probable causes of the connectivity issue from a plurality of available causes based on the network characteristics and the additional network characteristics, and generates a summary, wherein the summary indicates at least the one or more probable causes of the connectivity issue.

### BRIEF DESCRIPTION OF THE DRAWINGS

FIG. 1 illustrates a computing environment to identify probable causes of network connectivity issues according to an implementation.

FIG. 2 illustrates a method of operating a computing system to identify causes of a network connectivity issue according to an implementation.

FIG. 3 illustrates an operational scenario of monitoring networking characteristics and identifying causes of a connectivity issue according to an implementation.

FIG. 4 illustrates a sample summary for a connectivity issue according to an implementation.

FIG. 5 illustrates a computing system to identify causes of a network connectivity error according to an implementation.

### DETAILED DESCRIPTION

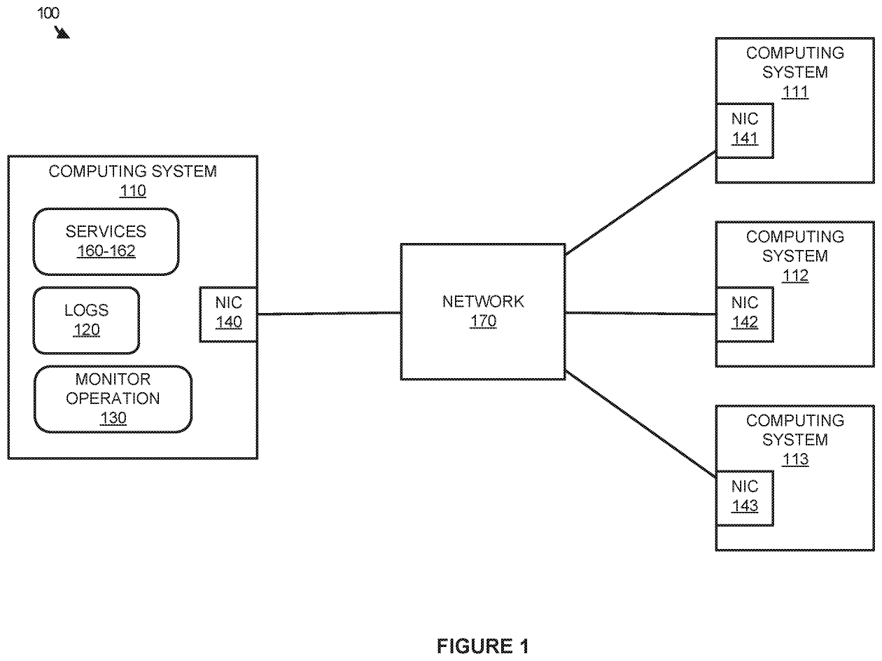

FIG. 1 illustrates a computing environment 100 to identify probable causes of network connectivity issues according to an implementation. Computing environment 100 includes computing systems 110-113 communicatively coupled using network 170. Computing system 110 further includes services 160-162, logs 120, monitor operation 130, and network interface (NIC) 140. Computing systems 111-113 further include NICs 141-143. Although demonstrated with each computing system including a single NIC, some computing systems may include multiple NICs.

In computing environment 100, computing systems 110-113 are deployed to provide a platform for various workloads. These workloads may use virtualization including virtualized endpoints, such as virtual machines and containers, and may further include virtualized network appliances, such as firewalls, routers, and gateways. For example, computing systems 111-113 may represent physical host computing systems that can each support the execution of one or more virtual machines, wherein the physical components of the hosts may be abstracted and provided to the virtual machines. The abstracted physical components may include processing systems, memory, storage, network interfaces, and the like. In some environments, a control or management computing system may be used to monitor workloads implemented in the computing environment and manage the workloads in the computing environment. This control computing system may obtain status information, such as resource usage, availability information, or some other information, and may further be used to deploy new virtualized endpoints, migrate endpoints, manage updates to the endpoints, or provide some management operation. For example, computing system 110 may communicate with computing systems 111-113 to manage the virtualization workloads deployed on the computing systems. Although demonstrated as a separate computing system in the previous example, the management computing system may reside wholly or partially on the computing systems hosting the workloads.

In some implementations, computing system 110 may monitor network characteristics associated with computing system 110 using monitor operation 130. These network characteristics may comprise network interface statistics associated with transmitted and received packet counts as a function of time for computing system 110, may comprise packet loss rate as a function of time, or may comprise some other network characteristic. For example, monitor operation may check maintain a log in logs 120 that indicates the packet loss rate as a function of time for packets received at NIC 140. In some implementations, the network characteristics may also include Internet Control Message Protocol (ICMP) ping status information for other computing systems in computing environment 100, port status information for other computing systems in computing environment 100, or some other information. As the network characteristics are monitored, computing system 110 may identify an error notification from a service in services 160-162 and may identify additional network characteristics based on the error notification. For example, service 160 may indicate an error communicating with computing system 111. In response to the notification, monitor operation 130 may generate additional tests to identify additional network characteristics associated with computing system 111. These additional tests may include ICMP pings to computing system 111, port status tests to computing system 111 and NIC 141, or some other tests of the connection to computing system 111. In some examples, computing system 110 may further request status information associated with one or more gateways between computing system 110-111, wherein the status information may indicate port status, availability status, or some other status information associated with the gateway.

After the additional network characteristics are determined for the connection between computing system 110 and computing system 111, monitor operation 130 may determine one or more probable causes for the connectivity issue between computing systems 110-111 based on the network characteristics and the additional network characteristics. For example, in response to identifying the error notification, monitor operation 130 may communicate an ICMP ping to computing system 111. If the ping is not received, monitor operation 130 may determine that computing system 111 is unavailable via a bad network connection or being powered off. Once the probable causes are determined in association with the error notification, a summary may be generated, wherein the summary may indicate the probable causes for the connectivity issue, may indicate statistics from network characteristics that were responsible for identifying the probable causes, may indicate possible solutions to the connectivity issue, or may indicate some other information. In some implementations, the summary may be stored as a log in logs 120 that can be accessed by one or more administrators associated with computing environment 100. In other examples, the summary can be distributed as part of an email, text, web notification, or some other notification to at least one administrator of computing environment 100.

In some implementations, the network characteristics monitored by computing system 110 may comprise local network characteristics, such as transmitted and received packet counts, while the additional network characteristics may correspond to the one or more specific connections between computing system 110 and the affected computing system. The additional network characteristics may comprise ICMP pings, port status requests, or some other status characteristics. In some implementations, the network characteristics may be monitored at a first sample rate and the additional network characteristics may be monitored at a second sample rate. For example, in response to receiving the error notification, monitor operation 130 may identify additional network characteristics at an increased rate over the monitored network characteristics.

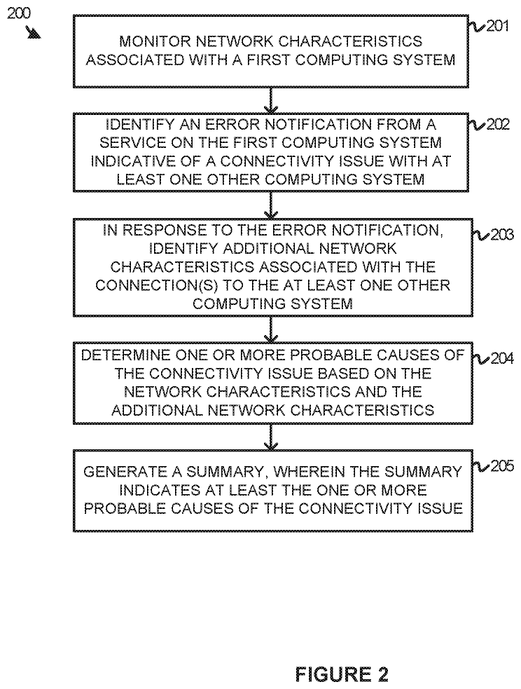

FIG. 2 illustrates a method 200 of operating a computing system to identify causes of a network connectivity error according to an implementation. The steps of method 200 are referenced parenthetically in the paragraphs that follow with reference to systems and elements of computing environment 100. While demonstrated as being performed by computing system 110, other computing systems 111-113 may perform similar operations to identify causes of network connectivity issues.

Method 200 includes monitoring (201) network characteristics associated with computing system 110, wherein the network characteristics may include network interface statistics associated with transmitted and received packet counts as a function of time, packet loss rate as a function of time, or some other statistic related to the communication of packets using NIC 140. In some implementations, the statistics may correspond to an individual computing system or may be aggregated for all computing systems in the computing environment. For example, the network characteristics may indicate packet loss rate as a function of time for all packets received from computing systems 111-113. The network characteristics may be stored as one or more logs of logs 120 for computing system 110.

As computing system 110 monitors the network characteristics, method 200 further provides for, identifying (202) an error notification from a service on the first computing system indicative of a connectivity issue with at least one other computing system and identifying (203) additional network characteristics associated with one or more connections to the at least one other computing system in response to the error notification. In some implementations, computing system 110 may communicate with computing systems 111-113 to manage virtualization processes distributed across computing systems 111-113. Computing system 110 may communicate with computing systems 111-113 to monitor resource usage on each of the computing systems, monitor virtual endpoints executing on each of the computing systems, manage the migration and deployment of endpoints at each of the computing systems, manage network appliances at each of the computing systems, or provide some other operation. The management may be accomplished using services 160-162.

In some examples, a service of services 160-162 may determine that one or more computing systems of computing systems 111-113 is experiencing a connection issue. For example, computing system 110 may be incapable of receiving status information from computing system 111 and may generate an error notification corresponding to the issue. In response to identifying the error notification, computing system 110 may identify additional network characteristics associated with one or more connections with computing system 111. The additional network characteristics may comprise ICMP ping status information for communicating with computing system 111, port status associated with computing system 111, or some other additional network characteristics associated with the connection with computing systems 111. In some examples, computing system 110 may monitor network characteristics at a first rate for all computing systems of computing systems 111-113. When an error notification is generated by a service, computing system 110 may gather additional network characteristics at a second rate, wherein the second rate comprise additional sampling than the first rate. For example, computing system 110 may generate more frequent samples associated with the packet loss rate or additional ICMP ping communications when an error notification is identified for a service of services 160-162.

After the network characteristics are identified, method 200 further provides for determining (204) one or more probable causes of the connectivity issue based on the network characteristics and the additional network characteristics. For example, the network characteristics identified prior to the error notification may be used to identify trends in communications prior to the error, such as the amount of dropped packets, the number of packets sent or received, or some other trend associated with the communications. The trends may then be compared to the network characteristics before or after the identification of the error. For example, computing system 110 may determine that the number of packets received prior to the error increased over the number of packets typically received over the same period. Accordingly, computing system 110 may identify that the increase in received packets may have caused the network call to fail or was unable to process all the received packets. In some examples, a single probable cause can be identified, however, multiple causes may be identified. In some implementations, computing system 110 may compare the network characteristics and the additional network characteristics to one or more criteria associated with various causes of connectivity issues. If the network characteristics and additional network characteristics do not satisfy the one or more criteria, then computing system 110 will not identify the corresponding cause for the connectivity issue. In contrast, if the network characteristics and additional network characteristics do satisfy the one or more criteria for a probable cause, then computing system 110 may identify the probable cause for the connectivity issue.

After the one or more probable causes are identified, computing system 110 generates (205) a summary, wherein the summary indicates at least the one or more probable causes of the connectivity issue. In some implementations, the summary may include a graphical summary of the network characteristics that contributed to the selection of the one or more probable causes. For example, a graph demonstrating the received packets as a function of time may be used to demonstrate the changes in the received packets that could have caused the connectivity issue. In some implementations, the summary may indicate the one or more probable causes as a list and may further indicate the network characteristics that were measured that contributed to the selection of each of the one or more probable causes. In some examples, the summary may further indicate one or more solutions for the connectivity issue, wherein the one or more solutions can be stored in a database that associates each of the solutions to a possible cause of the connectivity issue.

In some implementations, the summary may be stored as a log in logs 120, wherein an administrator of the computing environment can access the log to view the summary. In other implementations, the summary may be distributed via email, text, an application, or a web browser to an administrator of computing environment 100. In at least one example, the summary may be provided as a notification to the administrator that indicates the connectivity error and the one or more probable causes associated with the connectivity error. In some implementations, when multiple probable causes are identified in association with a connectivity issue, the summary may prioritize or order the various probable causes based on how the network characteristics and the additional network characteristics matched criteria associated with each of the probable causes. When more criteria are matched for a first probable cause in relation to another probable cause, the first probable cause may be promoted in the summary.

In some examples, computing system 110 may represent a management server capable of managing virtualization across computing systems 111-113. However, computing system 110 may comprise any computing system with one or more services that require communications with other computing systems. The services may include management services, monitoring service, or some other service.

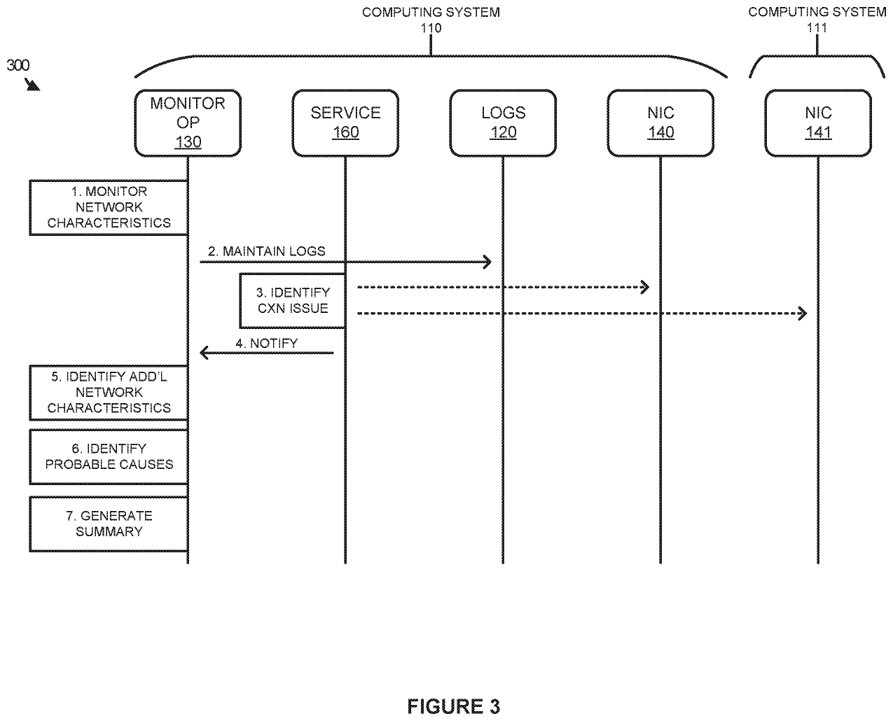

FIG. 3 illustrates a timing diagram 300 of monitoring networking characteristics and identifying causes of a connectivity issue according to an implementation. Timing diagram 300 includes monitor operation 130, service 160, logs 120, and NIC 140 for computing system 110 of FIG. 1. Timing diagram 300 further includes NIC 141 for computing system 111 of FIG. 1. Although demonstrated with a connectivity issue with computing system 111, similar operations may be performed when connectivity issues are identified with any computing system of computing systems 111-113.

In timing diagram 300, monitor operation 130 monitors network characteristics associated with computing system 110 communicating with other computing systems in the computing environment at step 1 and maintains the information as one or more logs of logs 120. The network characteristics may comprise network interface statistics associated with transmitted and received packet counts as a function of time or packet loss rate as a function of time. The statistics may be individual for each of the other computing systems or may be aggregated for each of the other computing systems. The network characteristics can be measured for NIC 140 and can be stored in one or more logs of logs 120. In some examples, at least a portion of the network characteristics can be provided by the other computing systems in the computing environment, wherein the other computing systems may provide information about transmitted and received packet counts, packet loss rate, or some other information. In some examples, monitoring operation 130 may perform additional operations to monitor network characteristics including communicating port status packets to identify open ports on other computing systems, perform ICMP ping communications with the other computing systems, or perform some other communication to monitor the status associated with the other computing systems. These additional operations can be performed at a first frequency rate in some examples.

As the network characteristics are monitored, service 160 may identify, at step 3, a connection issue associated with communications for NIC 141 and computing system 111. For example, service 160 may identify a connection issue when a status update is not provided from computing system 111 within a designated period, may identify a connection issue when an acknowledgment communication is not provided from computing system 111 in response to a command, or may identify a connection issue based on some other factor. In response to identifying the connection issue, service 160 may notify monitor operation 130 of the issue at step 4, wherein the notification may identify the other computing system using an IP address or some other identifying information associated with computing system 111.

In response to receiving the notification from service 160, monitor operation 130 further identifies additional network characteristics associated with the connection to NIC 141 of computing system 111. The additional network characteristics may comprise ICMP ping communications to NIC 141, port status requests to NIC 141, or some other requests associated with the individual connection to NIC 141. In some examples, monitor operation 130 may further request status information associated with one or more gateways between computing system 110 and computing system 111. In some implementations, the network characteristics may comprise statistics associated locally with transmitted and received packets for computing system 110 or dropped packets associated with computing system 110. In contrast, the additional network characteristics may correspond to information from status checks to the affected computing system, including the ICMP pings or port status checks. In some implementations, the at least a portion of the network characteristics can be identified at a first sample rate, while the additional network characteristics are identified at a different sample rate. For example, while monitor operation 130 may perform port status checks associated with computing system 111 at a first rate or frequency, the checks may become more frequent following the notification of the connection issue from service 160.

After identifying the additional network characteristics, monitor operation 130 identifies probable causes of the connection issue at step 6. In determining the probable causes, monitor operation 130 may compare the network characteristics and the additional network characteristics to one or more criteria associated with various available causes to network connection issues. If the network characteristics and the additional network characteristics do not satisfy the one or more criteria associated with a possible cause of the connectivity issue, then the cause is not identified. However, if the network characteristics and the additional network characteristics do satisfy the one or more criteria associated with a possible cause of the connectivity issue, then monitor operation 130 may select the cause as a possible cause for the connectivity issue. For example, the number of received packets during a period prior to the connectivity issue may exceed a threshold that indicates that one or more packets could not be processed in the requisite amount of time and NIC 140 was saturated.

Once the one or more probable causes are determined in association with the connectivity issue, monitor operation 130 generates a summary at step 7 that indicates at least the one or more probable causes associated with the connectivity issue. In some implementations, the summary may be stored in a log of logs 120, wherein an administrator may access the log to identify the causes of the issue. In other implementations, the summary may be communicated as an email, an application notification, or a notification to a web browser to the administrator indicating the one or more probable causes in association with the connectivity issue.

The summary may further indicate other information associated with the connectivity issue, including any information provided in the notification from service 160, network characteristics that were used in selecting the one or more probable causes from the available set of causes, one or more possible solutions associated with the one or more probable causes, or some other information related to the connectivity issue. In at least one implementation, one or more visual depictions may identify information relevant to selecting the probable causes. The visual depictions may indicate packets received/transmitted as a function of time, the packet loss rate at computing system 110 as a function of time, port status information on the computing systems of the computing environment, or some other visual depiction.

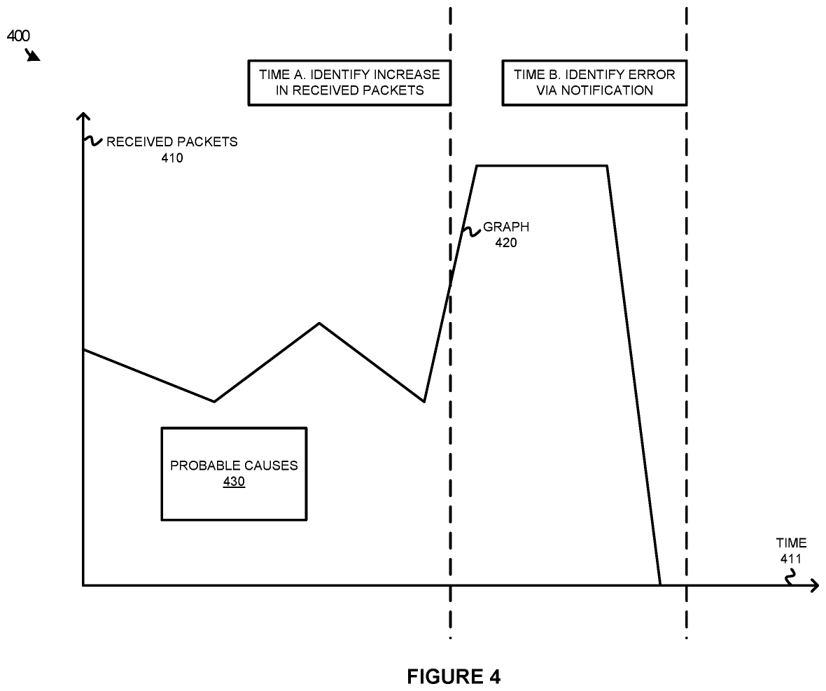

FIG. 4 illustrates a sample summary 400 for a connectivity issue according to an implementation. Sample summary 400 includes an axis for received packets 410 as a function of time 411. Sample summary 400 further includes graph 420 and probable causes 430. Although demonstrated with a line graph, a summary may include various graphical representations that can include graphs, tables, lists, or some other information related to a connectivity issue, including combinations thereof.

As described herein, a computing system in a computing environment may monitor network characteristics associated with the communications for the computing system, wherein the network characteristics may be related to transmitted and received packets as a function of time, packet loss as a function of time, or some other metric associated with local communication statistics at the computing system. While monitoring the network characteristics, a service executing on the computing system may indicate a connectivity issue with at least one other computing system in the computing environment. In some implementations, the at least one other computing system may comprise a host or some other computing element suitable for supporting virtualization of endpoints or network appliances managed by the computing system. In response to receiving the notification, the computing system may determine one or more probable causes associated with the connectivity issue from a plurality of connectivity issues. In some implementations, the computing system may determine the one or more probable causes using exclusively the network characteristics prior to the identification of the issue. In some implementations, the computing system may further use additional network characteristics that are identified in response to receiving the notification. For example, the network characteristics identified prior to the connectivity issue may be different than the network characteristics identified following the connectivity issue. In some implementations, the rate at which the network characteristics are monitored can be different prior the notification than after the notification. For example, the computing system may monitor network characteristics at a first rate prior to the error notification and may monitor additional network characteristics as a second, higher rate following the notification.

After identifying the one or more probable causes, the computing system generates a summary that can indicate at least the one or more probable causes. Here, probable causes 430 are identified for a connectivity issue and are displayed as part of sample summary 400. In addition to the probable causes, sample summary 400 further includes a graph 420 with an axis for received packets 410 and time 411. Graph 420 is added to sample summary 400 to indicate network characteristics that were used in identifying probable causes 430. Specifically, in this example, the computing system identifies a large increase in received packets at time A within a defined period of the notification of the network error from the service at time B. The increase in packets may satisfy criteria for probable causes 430. In some implementations additional network characteristics may be used to identify the probable causes and the additional network characteristics can be provided as part of the summary. Although demonstrated as a graph, the summary may be provided as a table, a list, or some other data structure or structures that can indicate one or more possible causes of a connectivity issue, the time of the connectivity issue, networking characteristics associated with identifying the one or more possible causes, or some other information associated with the connectivity issue

In some implementations, the summary may be stored as a log on the computing system accessible to an administrator of the computing environment. In other implementations, the summary can be provided as an email, application notification, or some other method to the administrator in response to generating the summary. In some examples, connectivity issues with specific identified possible causes can be provided to the administrator, while connectivity issues associated with other causes can be stored and accessed from a log on the computing system.

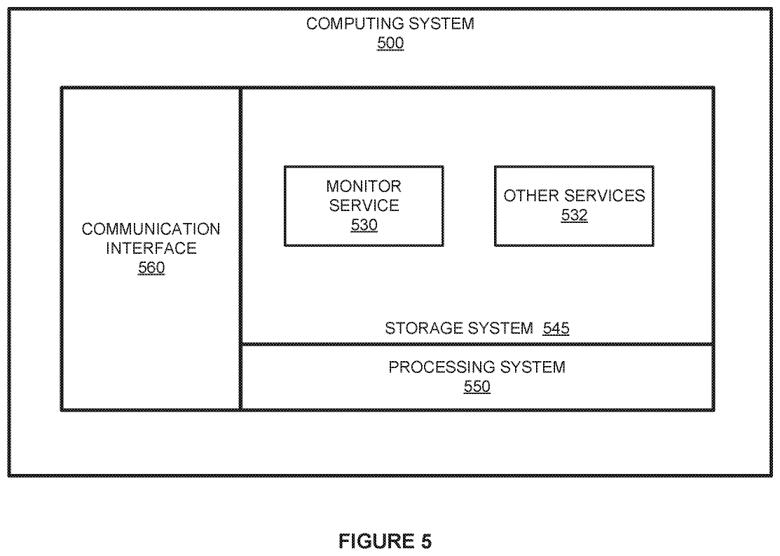

FIG. 5 illustrates a computing system 500 to identify causes of a network connectivity error according to an implementation. Computing system 500 is representative of any computing system or systems with which the various operational architectures, processes, scenarios, and sequences disclosed herein for a computing system in a computing environment, wherein the computing system may provide management services associated with virtualization in some examples. Computing system 500 is an example of computing system 110 of FIG. 1, although other examples may exist. Computing system 500 includes storage system 545, processing system 550, and communication interface 560. Processing system 550 is operatively linked to communication interface 560 and storage system 545. Communication interface 560 may be communicatively linked to storage system 545 in some implementations. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 may be configured to communicate with other computing systems, such as host computing systems, network edges, or some other computing system in a virtualization computing environment. In some implementations, computing system 500 may represent a management system for managing virtualized endpoints and other operations in a computing environment.

Processing system 550 comprises microprocessor and other circuitry that retrieves and executes operating software from storage system 545. Storage system 545 may include volatile and nonvolatile, removable, and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises monitor service 530 and other services 532. The operating software on storage system 545 may further include an operating system, utilities, drivers, network interfaces, applications, or some other type of software. When read and executed by processing system 550 the operating software on storage system 545 directs computing system 500 to operate as described herein. In at least one example, the operating software can provide at least operation 200 described above in FIG. 2.

In at least one implementation, monitor service 530 directs processing system 550 to monitor network characteristics associated with computing system 500 and communication interface 560. The network characteristics may be measured from transmission and received queues for the communication interface, dropped packet measurements associated with the communication interface, or some other source. The network characteristics may be stored as logs indicating changes in each characteristic as a function of time. While monitoring the network characteristics, monitor service 530 directs processing system 550 to an error notification from a service of other services 532 indicative of a connectivity issue with at least one other computing system. For example, a service that monitors the resource usage across multiple hosts may identify a connectivity issue with one of the hosts and provide a notification of the issue to monitor service 530. The connectivity issue may be identified when an acknowledgement is not received within a period, may be identified when data has not been received from the other computing system within a period, or may be identified based on some other triggering event. Although demonstrated as a separate service, monitor service 530 may be implemented wholly or partially as one of the services that provide the management operations for the virtualization computing environment.

In response to receiving the error notification, monitor service 530 directs processing system 550 to identify one or more possible causes of the connectivity issue from a plurality of available causes based on the network characteristics. In some implementations, monitor service 530 may compare the network characteristics to one or more criteria associated with each cause in the plurality of causes. When network characteristics do not satisfy the one or more criteria for a cause, then the cause will not be identified in association with the connectivity issue. In contrast, when the network characteristics do satisfy the one or more criteria for the cause, then the cause will be selected as a possible cause of the connectivity issue.

In some implementations, in addition to the monitoring the network characteristics, monitor service 530 directs processing system 550 to identify additional network characteristics in response to the error notification. The additional network characteristics may be used in conjunction with network characteristics to determine the one or more probable causes of the connectivity issue. In some examples, the additional network characteristics may comprise different characteristics than the monitored network characteristics. For example, the additional network characteristics may include ICMP ping information for the computing systems associated with the connectivity issue, port status information for the computing systems associated with the connectivity issue, or some other additional characteristics associated with the specific connectivity issue. In contrast, the network characteristics that are monitored by computing system 500 may include the number of transmitted and received packets, the packet loss rate, or some other communication information for computing system 500.

In some implementations, the additional network characteristics may be identified at a different rate than the monitored network characteristics. For example, prior to identifying a connectivity issue, the network characteristics may be identified at a first rate and after the connectivity issue, the additional network characteristics may be identified at a second higher rate.

After the one or more probable causes are identified, monitor service 530 directs processing system 550 to generate a summary that indicates at least the one or more probable causes. The summary may further include any of the network characteristics or additional characteristics that were used in selecting the one or more probable causes. The summary may also indicate one or more possible solutions that are associated with the probable causes, wherein the solutions may be stored in a database with the various causes. The solutions may include reestablishing connections or opening ports on unavailable computing systems, restarting one or more computing systems, reconfiguring one or more services or applications, or providing some other solution. In some implementations, the summary may be stored as a log on computing system 500 that is accessible by an administrator. In other implementations, the summary may be communicated to an administrator as an email, an application notification, or by some other mechanism.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method comprising:
monitoring network characteristics associated with a first computing system;
identifying an error notification from a service on the first computing system indicative of a connectivity issue with at least one other computing system;
in response to the error notification, identifying additional network characteristics associated with one or more connections from the first computing system to the at least one other computing system, wherein identifying the additional network characteristics comprises at least:
communicating one or more Internet Control Message Protocol (ICMP) ping communications from the first computing system to the at least one other computing system;
determining one or more probable causes of the connectivity issue from a plurality of available causes based on the network characteristics and the additional network characteristics; and
generating a summary, wherein the summary indicates at least the one or more probable causes of the connectivity issue.

2. The method of claim 1, wherein the network characteristics comprise at least network interface statistics associated with transmitted and received packet counts as a function of time or packet loss rate as a function of time.

3. The method of claim 1, wherein identifying the additional network characteristics further comprises initiating one or more port status tests associated with the at least one other computing system.

4. The method of claim 1, wherein determining the one or more probable causes of the connectivity issue based on the network characteristics and the additional network characteristics comprises:
determining that at least a portion of the network characteristics and the additional network characteristics satisfy criteria associated with the one or more probable causes.

5. The method of claim 1 further comprising:
identifying one or more solutions associated with the one or more probable causes; and
wherein the summary further indicates the one or more solutions.

6. The method of claim 1, wherein identifying the additional network characteristics further comprises:
communicating one or more status requests to one or more gateways supporting the one or more connections from the first computing system to the at least one other computing system to receive status information associated with the one or more gateways; and
receiving the status information from the one or more gateways.

7. The method of claim 1,
wherein monitoring the network characteristics associated with the first computing system comprises monitoring the network characteristics associated with the first computing system at a first sample rate; and
wherein identifying the additional network characteristics associated with the one or more connections to the at least one other computing system comprises identifying the additional network characteristics associated with the one or more connections at a second sample rate.

8. The method of claim 1, wherein the first computing system comprises a management computing system for a virtualization environment, and wherein the at least one other computing system comprises a host computing system in the virtualization environment.

9. A computing apparatus comprising:
a storage system;
a processing system operatively coupled to the storage system; and
program instructions stored on the storage system that, when executed by the processing system, direct the computing apparatus to:
monitor network characteristics associated with a first computing system;
identify an error notification from a service on the first computing system indicative of a connectivity issue with at least one other computing system;
in response to the error notification, identify additional network characteristics associated with one or more connections from the first computing system to the at least one other computing system, wherein identifying the additional network characteristics comprises at least:
communicating one or more Internet Control Message Protocol (ICMP) ping communications from the first computing system to the at least one other computing system;
determine one or more probable causes of the connectivity issue from a plurality of available causes based on the network characteristics and the additional network characteristics; and
generate a summary, wherein the summary indicates at least the one or more probable causes of the connectivity issue.

10. The computing apparatus of claim 9, wherein the network characteristics comprise at least network interface statistics associated with transmitted and received packet counts as a function of time or packet loss rate as a function of time.

11. The computing apparatus of claim 9, wherein identifying the additional network characteristics further comprises initiating one or more port status tests associated with the at least one other computing system.

12. The computing apparatus of claim 9, wherein determining the one or more probable causes of the connectivity issue based on the network characteristics and the additional network characteristics comprises:
determining that at least a portion of the network characteristics and the additional network characteristics satisfy criteria associated with the one or more probable causes.

13. The computing apparatus of claim 9, wherein the program instructions further direct the computing apparatus to:
identify one or more solutions associated with the one or more probable causes; and
wherein the summary further indicates the one or more solutions.

14. The computing apparatus of claim 9, wherein identifying the additional network characteristics further comprises:
communicating one or more status requests to one or more gateways supporting the one or more connections from the first computing system to the at least one other computing system to receive status information associated with the one or more gateways; and
receiving the status information from the one or more gateways.

15. The computing apparatus of claim 9,
wherein monitoring the network characteristics associated with the first computing system comprises monitoring the network characteristics associated with the first computing system at a first sample rate; and
wherein identifying the additional network characteristics associated with the one or more connections to the at least one other computing system comprises identifying the additional network characteristics associated with the one or more connections at a second sample rate.

16. The computing apparatus of claim 9, wherein the first computing system comprises a management computing system for a virtualization environment, and wherein the at least one other computing system comprises a host computing system in the virtualization environment.

17. A system comprising:
a plurality of computing systems;
a first computing system in the plurality of computing systems configured to:
monitor network characteristics associated with the first computing system;
identify an error notification from a service on the first computing system indicative of a connectivity issue with at least one other computing system in the plurality of computing systems;
in response to the error notification, identify additional network characteristics associated with one or more connections from the first computing system to the at least one other computing system, wherein identifying the additional network characteristics comprises at least”
communicating one or more Internet Control Message Protocol (ICMP) ping communications from the first computing system to the at least one other computing system;
determine one or more probable causes of the connectivity issue from a plurality of available causes based on the network characteristics and the additional network characteristics; and
generate a summary, wherein the summary indicates at least the one or more probable causes of the connectivity issue.

18. The system of claim 17, wherein the network characteristics comprise at least network interface statistics associated with transmitted and received packet counts as a function of time or packet loss rate as a function of time.

19. The system of claim 17, wherein identifying the additional network characteristics further comprises initiating one or more port status tests associated with the at least one other computing system.

20. The system of claim 17, wherein determining the one or more probable causes of the connectivity issue based on the network characteristics and the additional network characteristics comprises:
determining that at least a portion of the network characteristics and the additional network characteristics satisfy criteria associated with the one or more probable causes.
